(19) United States
(12) Patent Application Publication
(10) Pub. No.: US 2013/0152875 A1
(43) Pub. Date: Jun. 20, 2013

(54) DEVICE FOR CONTROLLING ANIMAL BEHAVIOR BY ALTERING SENSORIAL INPUT CUES

(71) Applicant: Joshua D. Levine, Chapel Hill, NC (US)

(72) Inventor: Joshua D. Levine, Chapel Hill, NC (US)

(21) Appl. No.: 13/715,153

(22) Filed: Dec. 14, 2012

Related U.S. Application Data
(60) Provisional application No. 61/576,169, filed on Dec. 15, 2011.

(51) Int. Cl. A01K 15/02

(52) U.S. Cl. CPC A01K 15/02
USPC 119/836

(57) ABSTRACT

A device for controlling the behavior of an animal, which animal has a neck, eyes, and a head, is provided. The device includes a collapsible hood having a length extending between a collar end and a muzzle end. The collapsible hood is configurable in a collapsed state wherein the collar end and the muzzle end are in close proximity to the collar. The collapsible hood is lengthwise extendable into a deployed state, wherein the collar end and muzzle end are separated from one another and the hood covers at least a portion of the animal's head including its eyes. In the collapsed state the device when mounted on the animal does not diminish the animal's ability to interact with, or sense, its environmental surroundings. In the deployed state the collapsible hood is operable to substantially diminish the animal's ability to sense environmental surroundings outside of the hood using one or more of vision, smell, and hearing.

The present application is entitled to the benefit of and incorporates by reference essential subject matter disclosed in U.S. Provisional Patent Application Ser. No. 61/576,169, filed Dec. 15, 2011.

### BACKGROUND OF THE INVENTION

1. Technical Field

The present invention relates to apparatus animal care products in general, and to devices for controlling animal behavior in particular.

2. Background Information

In some instances, an animal's handler may wish to quickly control the animal to prevent the animal from adopting an aggressive state, or to change an animal's aggressive state to a calmer state. The animal may be inclined to adopt an aggressive state based on sensory cues; e.g., visual, scent, hearing, etc. For example, a dog may adopt an aggressive state in response to seeing and/or smelling an approaching dog. As another example, a dog may adopt an aggressive state in response to the presence of an unknown person. If the animal handler can inhibit or remove the sensory cues, the animal will be easier to control and maintain in a safe condition.

What is needed is, therefore, is a device for controlling animal behavior, and in particular one that can inhibit an animal's ability to sense the environment that is apt to lead to aggressive behavior, and one that can be quickly deployed when a situation arises that might incite aggressive behavior from an animal.

### DISCLOSURE OF THE INVENTION

According to an aspect of the present invention, a device for controlling the behavior of an animal, which animal has a neck, eyes, and a head, is provided. The device includes a collapsible hood having a length extending between a collar end and a muzzle end. The collapsible hood is configurable in a collapsed state wherein the collar end and the muzzle end are in close proximity to the collar. The collapsible hood is lengthwise extendable into a deployed state, wherein the collar end and muzzle end are separated from one another and the hood covers at least a portion of the animal's head including its eyes. In the deployed state, the collapsible hood is operable to substantially impair the animal's ability to sense environmental surroundings outside of the hood using one or more of vision, smell, and hearing.

According to another aspect of the present invention, the device further includes a collar having an adjustable length, configurable so that the length encircles the neck of the animal. The collar end of the collapsible hood is attached, or is selectively attachable, to the collar.

The features and advantages of the present invention will become apparent in light of the detailed description of the invention provided below, and as illustrated in the accompanying drawings.

### BRIEF DESCRIPTION OF THE DRAWINGS

FIG. 1 illustrates an embodiment of the present device shown in a deployed state.

FIG. 2 illustrates an embodiment of the present device shown in a collapsed state mounted on a dog.

FIG. 3 illustrates an embodiment of the present device in a deployed state mounted on a dog, covering the dog's eyes and ears.

FIG. 4 illustrates an embodiment of the present device in a deployed state mounted on a dog, covering the dog's eyes, ears, and nose. This figure also illustrates the deployment of structure to enhance sensory deprivation or distraction.

FIG. 5 illustrates an embodiment of the present device in a deployed state.

FIG. 6 illustrates an embodiment of the present device in a deployed state, with a collapsible hood having a collar end with a circumferential open configuration.

FIG. 7 illustrates an embodiment of the present device in a deployed state with a collar.

### DETAILED DESCRIPTION

The present device 18 for controlling the behavior of an animal includes a collapsible hood 20, and also a collar 21 in some embodiments. The device will be described hereinafter in the context of a canine application, in which application it has particular utility, but the invention is not limited to use to a canine application. In a deployed state (as will be described below), the collapsible hood is operable to substantially impair the animal's ability to sense environmental surroundings outside of the hood using one or more of vision, smell, and hearing. The term “substantially impair the animal's ability to sense environmental surroundings outside of the hood using one or more of vision, smell, and hearing” is used herein to describe that the animal's ability to visually, auditorily, and/or olfactorily sense environmental factors outside of its immediate proximity will be substantially diminished.

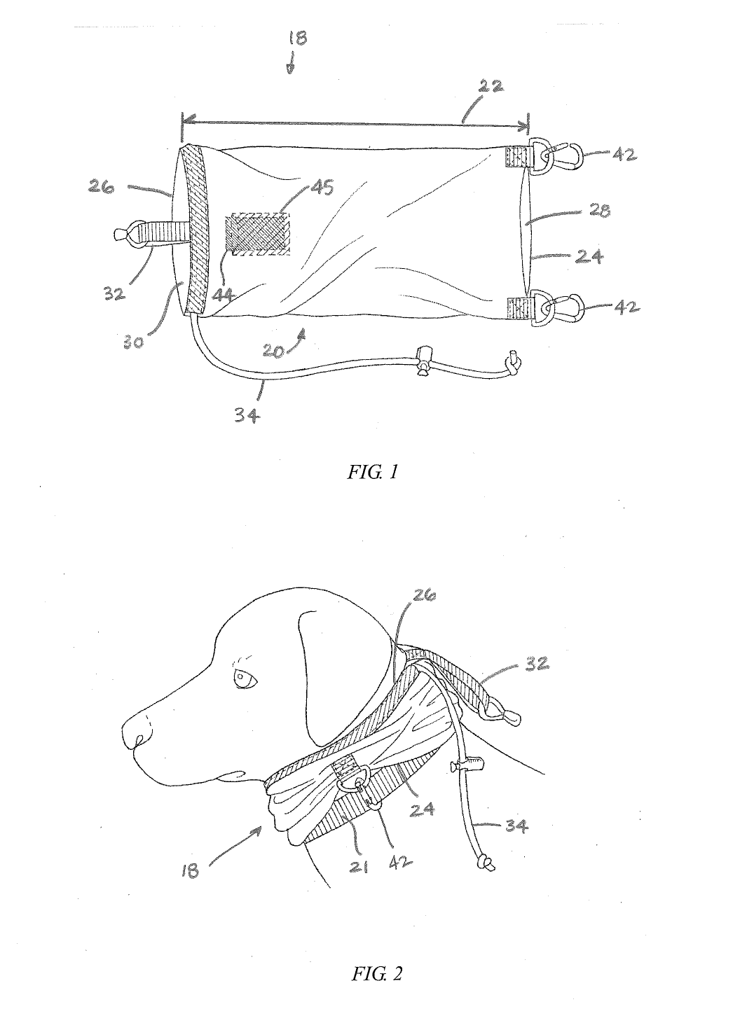

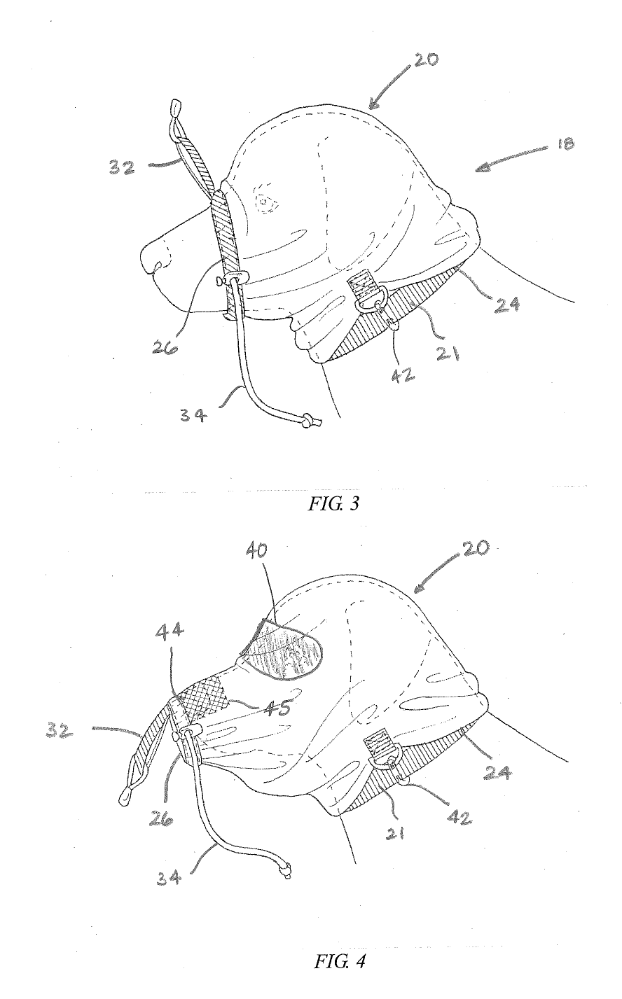

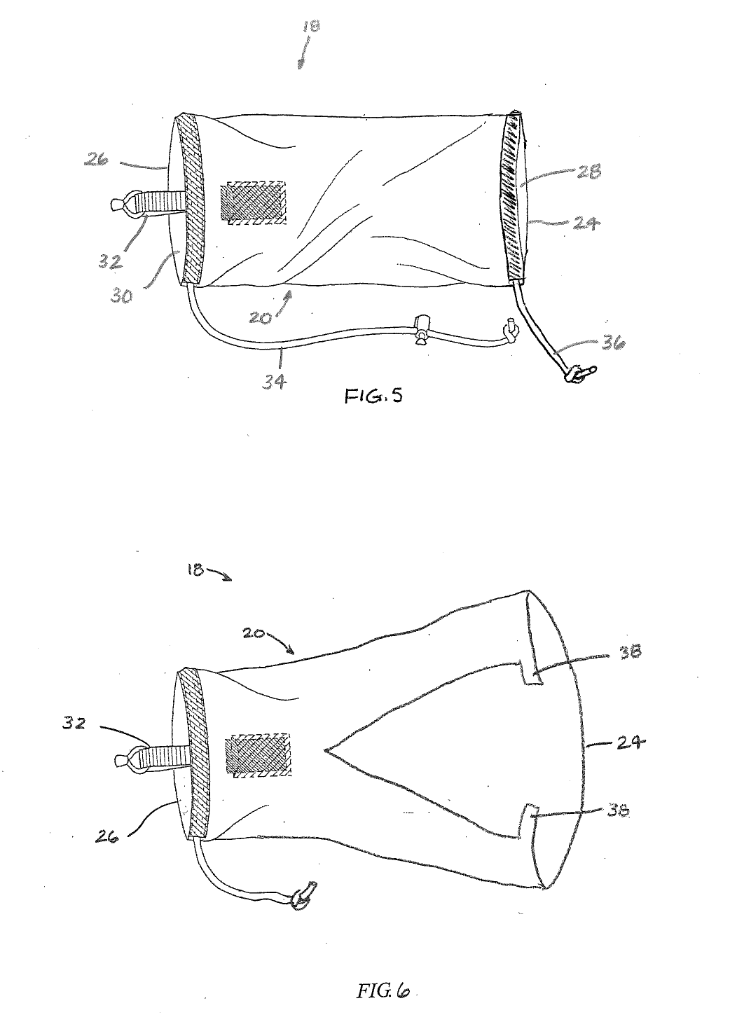

Referring to FIGS. 1-4, the collapsible hood 20 has a length 22 extending between a collar end 24 and a muzzle end 26. The collar end 24 has an opening 28 with a cross-sectional area and the muzzle end 26 has an opening 30 with a cross sectional area. The hood 20 is configurable in a collapsed state wherein the collar end 24 and the muzzle end 26 are in close proximity to one another. FIG. 2 illustrates the device in a collapsed state around a dog's neck. In the collapsible state, the hood 20 is configured to avoid hindering any of the animal's normal activities. The hood 20 is lengthwise extendable into a deployed state, wherein the collar end 24 and muzzle end 26 are separated from one another and the hood 20 covers at least a portion of the animal's head including its eyes. FIGS. 3 and 4 illustrate the device 18 in a deployed state. At least portions of the hood 20 are made of a material that is sufficiently non-transparent to inhibit the animal's ability to see through the hood 20. Examples of acceptable materials include microfiber polyester, finely-knit wool, finely-knit acrylic, etc. In some embodiments, the hood material is air permeable; e.g., to make the device comfortable for the animal to wear. In some embodiments, the hood material may contain a material that inhibits the transfer of odors through the material, and/or contains a material that emits an odor likely to affect the animal's behavior; e.g., a material that provides an odor that is pleasing or calming to the dog such as a food odor, etc. In some embodiments, the hood material is elastic and configured such that the hood 20 will closely fit the animal's head when deployed, and may apply a slight pressure on the animal. The embodiments shown in FIGS. 1-4 illustrate a collapsible hood 20 that is selectively attachable to a collar 21. In FIGS. 1-4, clips 42 are used to selectively attach the collapsible hood to the collar 21, but the present invention is not limited to clips 42; e.g., the hood 20 may be attached using Velcro^{l}'^{m} type hook and loop fasteners, snaps, etc.

In some embodiments, the hood 20 includes one or more members 32 (e.g., tabs, cords, etc.; see FIGS. 1 and 2) attached to the muzzle end 26 configured such that the animal handler can grab the member 32 and use it to quickly draw the hood 20 over the animal's head, changing the hood 20 from a collapsed state to a deployed state. The one or more members 32 are preferably located on the device at a position where the animal handler can easily grab the member 32 and quickly deploy the hood 20.

Embodiments of the hood 20 may have different lengths 22. For example, in the embodiment shown in FIG. 3, the hood length 22 is such that the hood 20 extends over the animal's eyes but not past his nose. In the embodiment shown in FIG. 4, the hood length 22 is such that the hood 20 extends over the animal's eyes and past his nose.

Referring to FIG. 3, the muzzle end 26 of the hood 20 may be loose fitting, or may include a biasing means 34 (e.g., an elastic, draw cord, etc) that conforms the muzzle end 26 to the dog's muzzle, or at least partially closes the muzzle end 26 if the muzzle end 26 is configured to be drawn past the animal's nose. The collar end 24 of the hood 20 may similarly be loose fitting, or may include a biasing means 36 (e.g., an elastic, draw cord, Velcro™ tabs, etc.—see FIG. 5) that fits the collar end 24 to the dog's neck.

In some embodiments, the entire collapsible hood 20 may be made from an elastic material that causes the collapsible hood 20 to conform to the animal's head when deployed on an animal's head. The elasticity of the material will exert a mild pressure on the animal's head which may contribute to calming the animal. In these embodiments both the collar and the muzzle ends 24, 26 of the hood 20 are circumferentially closed and are drawn over the animals muzzle and head to a position around its neck when mounting the device on the animal. In other embodiments (e.g., FIG. 6), one or both of the collar end 24 and the muzzle end 24 of the hood 20 may have an open configuration; e.g., FIG. 6 shows an embodiment of the hood 20 with an open configuration collar end 26, having lateral ends 38 that attach to one another to encircle the animal's neck. The lateral ends 38 may be attached to one another using attachment hardware such as a buckle, Velcro™ type hook and loop fasteners, snaps, tie cord, etc.

In some embodiments, the hood 20 may include material 40 (e.g., padding, light blocking material—e.g., see FIG. 4) positioned to align with the animal's eyes, ears, and/or nose when the device 18 is deployed to enhance the sensory deprivation of the animal; e.g., light blocking pads located to align with the animal's eyes in the deployed position. This material is in addition to the hood material, and may be the sole basis for sensory deprivation, or may be added to enhance the sensory deprivation provided by the hood material. In some embodiments, a piece of material 44 (e.g., a “scent patch”—see FIG. 4) may be attached to the hood 20, which material 44 emits an odor likely to affect the animal's behavior; e.g., a material that provides an odor that is pleasing, calming, and/or distracting to the dog such as a strong odor, food odor, owner scent, calming pheromone, etc. The material 44 may be permanently attached to the hood 20, or may be attached in a manner where it can be readily removed; e.g., for “recharging” of odor. The embodiment shown in FIGS. 1 and 4 illustrates the hood having a pocket 45 for receiving the material 44 that produces the odor; e.g., a pocket 45 configured to receive a material 44 such as dog food, a food treat, etc.

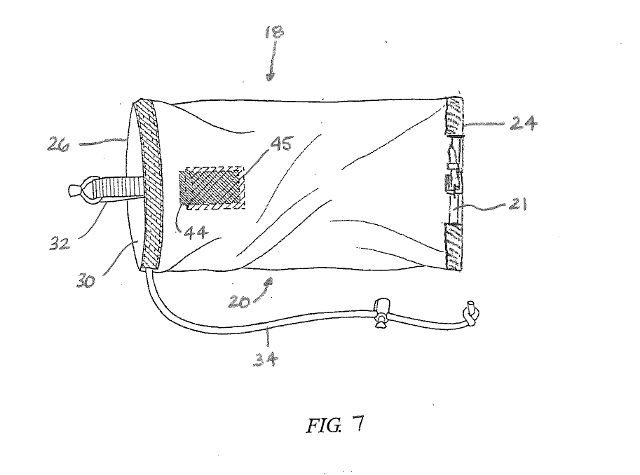

Referring to FIG. 7, as indicated above some embodiments of the present device include a collar 21 in addition to the collapsible hood 20. In these embodiments, the collapsible hood 20 is attached to the collar 21. The collar 21 has a length selected so that the collar 21 encircles the neck of the animal, and is adjustable to facilitate sizing the collar 21 relative to the animal's neck. In some embodiments, the collar 21 may be configured to operate as a physical control structure (e.g., like a conventional dog collar) and as a retaining structure for the collapsible hood 20. In other embodiments, the collar 21 may be configured to operate as only a retaining structure for the collapsible hood 20. For example, if an animal handler uses a harness type control structure on a dog, the collar 21 portion of the present device may be used only to retain the present device and not be used as a physical control structure. The collar 21 typically includes closing structure such as a buckle, Velcro^{lm} type hook and loop fasteners, snaps, etc.

The sizing of the present device 18 may vary to fit particular animals. For example, the present device may have a “miniature” size that fits miniature breeds of dogs (e.g., small terriers), a medium size that fits medium breeds of dogs (e.g., beagles, etc.), and a large size that fits large breeds of dogs (e.g., retrievers, etc). The present device 18 is not limited to any particular size.

When the present device 18 is initially mounted on the animal, the hood 20 is typically deployed in the collapsed state where the collar and muzzle ends 24, 26 of the hood 20 are in close proximity to one another. The specific manner in which the device 18 is mounted on the animal will depend on the particular embodiment used. For example, if the present device 18 is configured such that the collar end 24 of the hood 20 has an open configuration and the muzzle end 26 has a closed configuration, the muzzle end 26 may be drawn over the animal's head, and the lateral ends 38 of the hood collar end 24 may be attached to one another to “close” the collar end 24 of the collapsible hood 20. In other embodiments where the present device has a tube-like configuration, both the collar and the muzzle ends 24, 26 of the hood 20 are drawn over the animals muzzle and head to a position around its neck when mounting the device on the animal. In those embodiments of the present device that include a collar 21, or that are intended to be used with an existing collar, the collapsible hood 20 can be attached to the collar 21.

To deploy the collapsible hood 20 and thereby operate the present device, the animal handler draws the hood 20 over the animal's head. The animal handler may deploy the hood 20, for example, by grabbing a member 32 attached to the muzzle end 26 and drawing it over the animal's head. In the deployed position, the hood 20 will extend over the animal's eyes and a distance toward the animal's nose. Depending on the embodiment of the collapsible hood 20, the length 22 of the hood 20 may be such that the hood 20 does not extend over the animal's nose, or the length 22 may be long enough so that the hood 20 will extend over the animal's nose as well. Once the circumstances that necessitated use of the device have changed, the hood 20 may be quickly and easily drawn back to the collapsed state around the animal's neck while the hood 20 remains mounted on the animal.

The present device provides numerous advantages, including: a) it allows a dog to be in a public setting without the great discomfort (and social stigma) of a muzzle; b) it allows a dog to breathe, smell, eat and drink normally (actions that may hindered by a conventional muzzle); c) it is easy and harmless to use; d) it is inexpensive to manufacture; e) it temporarily disables one or more of a dog's vision, smell, or hearing which tends to calm the animal; f) the loss of the sense of sight can help prevent the dog from acting on his aggressive impulses; g) a partial loss of the sense of smell can help prevent the dog from acting on aggressive impulses; h) an addition of a distracting and/or calming odor on the fabric (or a “scent patch”, etc.) can help to further calm the dog and distract him from a perceived threat; i) the hood 20 covering and pressing against the dog's ears will result in a diminished (but still present) sense of hearing, thereby helping to further calm the dog and distract him from the perceived threat; j) the device can be left in place around the dog's collar 21 without hindering any of the dog's normal activities; k) the device can be employed in seconds; the device can be deployed with a minimum of effort, regardless of whether the dog is cooperating or not; and 1) the device can be quickly collapsed back to its original position around the dog's neck thereby returning the animal to an unhindered state where none of his senses are diminished.

What is claimed is:

1. A device for controlling the behavior of an animal, which animal has a neck, eyes, and a head, the device comprising:
a collapsible hood having a length extending between a collar end and a muzzle end, wherein the hood is configurable in a collapsed state wherein the collar end and the muzzle end are in close proximity to the collar, and in the collapsed state when mounted on the animal the hood does not diminish the animal's ability to interact with, or sense, its environmental surroundings; and
wherein the hood is lengthwise extendable into a deployed state, wherein the collar end and muzzle end are separated from one another and the hood covers at least a portion of the animal's head including its eyes, and wherein in the deployed state the collapsible hood is operable to substantially diminish the animal's ability to sense environmental surroundings outside of the hood using one or more of vision, smell, and hearing.

2. The device of claim 1, further comprising a collar having an adjustable length, which collar is configurable so that the length encircles the neck of the animal, wherein the collar end is attached, or is selectively attachable, to the collar.

3. The device of claim 1, wherein in the deployed state the hood is lengthwise extendable to cover at least a portion of the animal's head including its eyes and nose.

4. The device of claim 1, wherein the collar end has an opening cross-sectional area and the muzzle end has an opening cross-sectional area, and the collapsible hood includes a structure for decreasing the opening area of the muzzle end.

5. The device of claim 4, wherein the structure for decreasing the opening area of the muzzle end includes an elastic member retained at the muzzle end of the hood.

6. The device of claim 1, wherein the hood comprises a substantially non-transparent material.

7. The device of claim 1, wherein the hood comprises an air permeable material.

8. The device of claim 1, wherein the hood material contains a material that emits an odor that affects the animal's behavior.

9. The device of claim 1, wherein the hood includes a piece of material that emits an odor that affects the animal's behavior.

10. The device of claim 9, wherein the piece of material is configured to permit recharging of the odor.

11. The device of claim 1, wherein the hood includes a pocket for retaining a material or food item that emits an odor that affects the animal's behavior.

12. The device of claim 1, wherein the collapsible hood material comprises an elastic material and the hood is configured to closely fit and exert a mild pressure on the animal's head when deployed.

13. The device of claim 1, wherein the collapsible hood further comprises one or more members extending out from the muzzle end, which member is configured such that moving the member away from the collar end a sufficient distance will cause the collapsible hood to extend into a deployed state.

14. The device of claim 1, wherein the collar end of the collapsible hood includes a pair of lateral ends, and wherein the collar end can selectively assume an open circumferential configuration wherein the lateral ends are not attached to one another, and a closed circumferential configuration wherein the lateral ends are attached to one another and the collar end is operable to encircle the animal's neck.

15. The device of claim 14, wherein the muzzle end of the collapsible hood has a closed circumferential configuration.

16. The device of claim 1, wherein the collar end and the muzzle end of the collapsible hood each have a closed circumferential configuration.

17. The device of claim 1, wherein the hood collapsible includes material positioned to align with one or more of the animal's eyes, ears, and nose when the collapsible hood is in a deployed state.

18. The device of claim 1, wherein the hood is operable to be readily changed from both the collapsed state to the extended state and from the extended state to the collapsed state while mounted on the animal.
